(19) United States
(12) Patent Application Publication
(10) Pub. No.: US 2020/0056954 A1
(43) Pub. Date: Feb. 20, 2020

(54) OVERPRESSURE PROTECTION SYSTEM

(71) Applicant: GENERAL ELECTRIC COMPANY, Schenectady, NY (US)

(72) Inventors: Dag WANG, Oslo (NO); Bjorn Erik SEEBERG, Oslo (NO); Christian NOMME, Oslo (NO)

(21) Appl. No.: 16/610,178

(22) PCT Filed: May 1, 2018
(86) PCT No.: PCT/US2018/030356

§ 371 Date: Nov. 1, 2019

Related U.S. Application Data
(60) Provisional application No. 62/500,127, filed on May 2, 2017.

(51) Int. Cl. G01L 19/06; G01L 13/02

(52) U.S. Cl. CPC G01L 19/0618; G01L 13/026

(57) ABSTRACT

An overpressure protection system and methods of using the same are provided. The overpressure protection system can include at least two limiting diaphragms in fluid communication with corresponding overpressure diaphragms. Each limiting diaphragm can be configured to transmit pressure exerted by different fluid environments to their corresponding overpressure diaphragm. Each overpressure diaphragm can include a pre-tensioned diaphragm seal configured to allow transmission of pressures to a differential pressure sensing element, allowing measurement of a differential pressure between the different fluid environments. When pressure transmitted to an overpressure diaphragm reaches a pre-defined limit, the pre-tensioned diaphragm can inhibit transmission of further pressure increases to the differential pressure sensing element. The overpressure protection system can employ a relatively small volume of transmission fluid T for pressure transmission, reducing the size of the overpressure protection system and increasing its responsiveness.

### CROSS-REFERENCE TO RELATED APPLICATIONS

This application claims the benefit of U.S. Provisional Patent Application No. 62/500,127, filed May 2, 2017, entitled “Over Pressure Protection System,” the entirety of which is hereby incorporated by reference.

### BACKGROUND

Fluids such as liquids and/or gases can be conveyed through pipes for transportation between locations. In order to control flow of the fluid within a network of pipes, pressure can be applied to the fluid and measured at a variety of locations. As an example, a pressure measurement can be performed by placing a pressure sensor in contact with the fluid.

Differential pressure sensors are a type of pressure sensor that can measure differences in pressure between two different inputs. As an example, a differential pressure can be measured between different locations of a fluid within a pipe network or between a fluid and a reference (e.g., atmosphere). Differential pressure sensors can be designed to measure pressure differences up to a predetermined maximum. However, if exposed to a pressure difference that exceeds this maximum, a differential pressure sensor can become damaged.

### SUMMARY

In general, systems and methods are provided for overpressure protection of pressure sensors, such as differential pressure sensors.

In one embodiment, an overpressure protection system is provided and it can include a limiting diaphragm assembly and an overpressure diaphragm assembly. The limiting diaphragm assembly can be configured to receive a first pressure from a first fluid environment. The overpressure diaphragm assembly can include an overpressure diaphragm assembly base having a generally convex surface and an overpressure diaphragm seal coupled to the convex surface. The overpressure diaphragm assembly can be configured to receive the first pressure from the limiting diaphragm assembly via hydraulic communication with a transmission fluid at a first side of the overpressure diaphragm seal. The overpressure diaphragm assembly can also be configured to receive a second pressure from a second fluid environment at a second side of the overpressure diaphragm seal, opposite the first side. The overpressure diaphragm seal can be biased towards the convex surface by a lift-off pressure. The magnitude of the lift-off pressure can be approximately equal to the sum of the magnitudes of the second pressure and a pre-defined residual diaphragm pressure of the overpressure diaphragm seal. The transmission fluid can exert the first pressure on the overpressure diaphragm seal in a direction opposite the lift-off pressure. The limiting diaphragm assembly and the overpressure diaphragm assembly can be configured to allow transmission of the first pressure having a magnitude less than or equal to a pre-defined cutoff pressure to a pressure sensing element. The limiting diaphragm assembly and the overpressure diaphragm assembly can also be configured to inhibit transmission of the first pressure having a magnitude greater than the cutoff pressure to the pressure sensing element. The magnitude of the cutoff pressure can be greater than the magnitude of the lift-off pressure.

In another embodiment, the limiting diaphragm assembly can include a limiting diaphragm base having a generally concave surface and a generally planar limiting diaphragm seal. The limiting diaphragm seal can overly the concave surface and couple to the limiting diaphragm base. The limiting diaphragm base and the limiting diaphragm seal can define a first cavity in the limiting diaphragm base having a first cavity volume V_{c1} substantially filled with the transmission fluid. The overpressure diaphragm seal can separate the transmission fluid from the first fluid environment and receive the first pressure.

In another embodiment, a second cavity having a second cavity volume V_{c2} can be defined between the overpressure diaphragm seal and the concave surface of the overpressure diaphragm base.

Embodiments of the overpressure diaphragm seal and second cavity volume V_{c2} can adopt a variety of configurations. In one aspect, when the first pressure is less than or equal to the lift-off pressure, the overpressure diaphragm seal can be configured to substantially abut the overpressure diaphragm base and the second cavity volume V_{c2} can be approximately zero.

In another aspect, when the first pressure is greater than the lift-off pressure and less than the cutoff pressure, the overpressure diaphragm seal can be configured to deflect away from the overpressure diaphragm base such that the second cavity volume V_{c2} is less than the first cavity volume V_{c1}. The limiting diaphragm seal can be configured to deflect towards the limiting diaphragm base in response to deflection of the overpressure diaphragm seal and to urge a volume of transmission fluid substantially equal to the second cavity volume V_{c2} from the first cavity to the second cavity.

In another aspect, when the first pressure is substantially equal to the cutoff pressure, the overpressure diaphragm seal can be configured to deflect away from the overpressure diaphragm base such that the second cavity volume V_{c2} is substantially equal to the first cavity volume V_{c1}. The limiting diaphragm seal can be configured to deflect towards the limiting diaphragm base in response to deflection of the overpressure diaphragm seal and to urge a volume of transmission fluid substantially equal to the first cavity volume V_{c1} from the first cavity to the second cavity.

In another embodiment, when the first pressure is greater than the cutoff pressure, the limiting diaphragm seal can be configured to seat against the limiting diaphragm base and to inhibit transmission of the first pressure greater than the cutoff pressure to the overpressure diaphragm assembly.

In another embodiment, the coupling between the overpressure diaphragm seal and the overpressure diaphragm base can be configured to break when the first pressure exceeds a predefined rupture pressure greater than the cutoff pressure.

In another embodiment, the rupture pressure can be less than or equal to a maximum pressure of the pressure sensing element.

In one embodiment, a pressure sensor is provided and it can include the pressure sensing element and the overpressure protection system in hydraulic communication with the pressure sensing element by the transmission fluid.

Methods for overpressure protection are provided. In one embodiment, the method can include receiving a first pressure from a first fluid environment at a deformable limiting diaphragm assembly. The method can also include hydraulically transmitting the received first pressure from the limiting diaphragm assembly to an overpressure diaphragm assembly by a transmission fluid. The first pressure can be applied to an overpressure diaphragm seal coupled to a generally convex surface of an overpressure diaphragm base in a first direction away from the overpressure diaphragm base. The method can further include receiving a second pressure from a second fluid environment at the overpressure diaphragm seal. The method can additionally include urging the overpressure diaphragm seal in a second direction, opposite the first direction and towards the overpressure diaphragm base, by a lift-off pressure. The lift-off pressure can be approximately equal to the sum of a pre-defined residual diaphragm pressure of the overpressure diaphragm seal and the second pressure. The method can also include inhibiting transmission of the first pressure from the overpressure diaphragm assembly to a pressure sensing element by the transmission fluid when the magnitude of the first pressure is greater than a magnitude of a pre-defined cutoff pressure. The magnitude of the cutoff pressure can be greater than the magnitude of the lift-off pressure.

In another embodiment, the method can include permitting transmission of the first pressure from the overpressure diaphragm assembly to the pressure sensing element by the transmission fluid when the magnitude of the first pressure is less than or equal to the magnitude of the cutoff pressure.

In another embodiment, the method can include containing a volume V_{c1} of transmission fluid within a first cavity of the limiting diaphragm assembly, where the transmission fluid can substantially fill the first cavity. The method can also include deflecting the overpressure diaphragm seal in the first direction when the first pressure is greater than the lift-off pressure, thereby defining a second cavity having a volume V_{c2} between the overpressure diaphragm seal and the overpressure diaphragm base. The method can further include transferring a portion of the transmission fluid substantially equal to volume V_{c2} from the first cavity to the second cavity.

In another embodiment, the volume V_{c2} can be approximately zero when the first pressure is less than or equal to the lift-off pressure.

In another embodiment, the volume V_{c2} can be less than the volume V_{c1} when the first pressure is less than the cutoff pressure.

In another embodiment, the volume V_{c2} can be substantially equal to the volume V_{c1} when the first pressure is substantially equal to the cutoff pressure.

In another embodiment, the method can include breaking the coupling between the overpressure diaphragm seal and the overpressure diaphragm base when the first pressure is greater than a rupture pressure, the rupture pressure being greater than the cutoff pressure.

### DESCRIPTION OF DRAWINGS

These and other features will be more readily understood from the following detailed description taken in conjunction with the accompanying drawings, in which:

FIG. 1 is a schematic illustration of an overpressure protection system including a large protection diaphragm;

FIG. 2 is a schematic illustration of one exemplary embodiment of an overpressure protection system including pre-tensioned overpressure diaphragms;

FIG. 3A is an exploded side view of one exemplary embodiment of a pre-tensioned overpressure diaphragm;

3B is side cross-sectional view of the pre-tensioned overpressure diaphragm of FIG. 3A;

FIG. 4 is a flow diagram illustrating one exemplary embodiment of a method for assembling the pre-tensioned overpressure diaphragm of FIGS. 3A-3B;

FIG. 5A is an exploded side view of another exemplary embodiment of a pre-tensioned overpressure diaphragm;

FIG. 5B is an exploded side cross-sectional view of the pre-tensioned overpressure diaphragm of FIG. 5A;

FIG. 6 is a flow diagram illustrating one exemplary embodiment of a method for assembling the pre-tensioned overpressure diaphragm of FIGS. 5A-5B;

FIG. 7A is a schematic illustration of a pre-tensioned overpressure diaphragm and a limiting diaphragm of the overpressure protection system of FIG. 2 at an applied pressure less than a lift-off pressure P_{L};

FIG. 7B is a schematic illustration of a pre-tensioned overpressure diaphragm and a limiting diaphragm of the overpressure protection system of FIG. 2 at an applied pressure equal to a cut-off pressure P_{C};

FIG. 7C is a plot of pressure and volume illustrating a volume of a transmission fluid T displaced from a limiting diaphragm to a pre-tensioned overpressure diaphragm of FIG. 2;

FIG. 8 is a schematic illustration of an exemplary embodiment of a combination pressure sensor including two differential pressure sensing elements employing respective overpressure protection systems; and

FIG. 9 is a flow diagram illustrating an exemplary embodiment of a method for overpressure protection.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Differential pressure sensors are devices that can measure a difference between two pressures, and can be used in a variety of applications. In one aspect, differential pressure sensors can be used to measure pressure drops across filters, such as air filters in HVAC systems and oil filters in engines. In another aspect, differential pressure sensors can be used to measure fluid levels in tanks and other fluid containing vessels. In a further aspect, differential pressure sensors can be used to measure flow rates of fluids (e.g., gases, liquids) in pipes. However, if the pressure difference applied to a differential pressure sensor is too great, it can be damaged.

Differential pressure sensors can use a pressure sensing element to measure the difference between two different pressures. The pressure sensing element can be coupled to inputs that receive the two pressures and output signals representing measurements of the pressure difference. Since differential pressure sensors can be used in high pressure environments, they can include a mechanism to protect the pressure sensing elements from damage due to differential pressures that exceed a pre-determined level, referred to as overpressure. As an example, these protection mechanisms can include tubes that contain a transmission fluid for transmitting the different pressures to the pressure sensing element and a chamber that receives the transmission fluid when the pressures exceed the pre-determined level. However, the amount of transmission fluid used by these protection mechanisms can be relatively large and they can respond slowly to pressure changes, leaving the pressure sensing elements vulnerable to damage from rapidly changing pressures. Also, the chamber can be relatively large to accommodate the volume of transmission fluid, increasing the size of the differential pressure sensor. Accordingly, overpressure protection systems for differential pressure sensors are provided that include an improved chamber that employs a significantly lower volume of transmission fluid to provide overpressure protection, allowing for a reduction in size of a differential pressure sensor and improved response time. The transmission fluid can also be routed through these overpressure protection systems in a manner that inhibits transmission of pressure spikes to pressure sensing elements.

Embodiments of overpressure protection systems are discussed herein with reference to differential pressure sensors. However, embodiments of the disclosure can be employed in any application without limit.

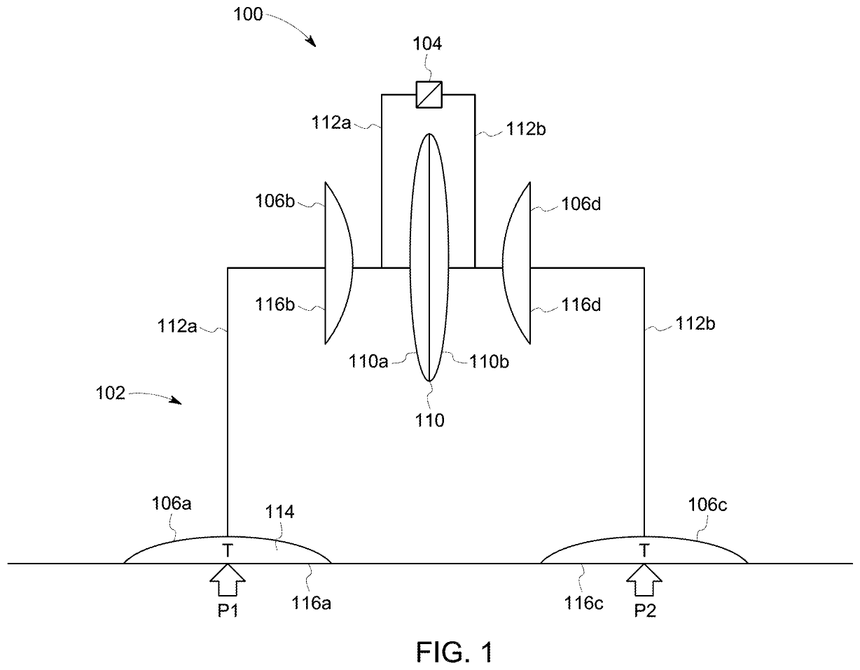

FIG. 1 illustrates a differential pressure sensor 100 that includes an existing overpressure protection system 102 employing a relatively large volume of transmission fluid and a differential pressure sensing element 104. The differential pressure sensing element 104 can be configured to measure a pressure difference between a first input at a pressure P1 and a second input at a pressure P2. As shown, the overpressure protection system 102 can include limiting diaphragm assemblies 106a, 106b that are in communication via capillaries 112a with both the differential pressure sensing element 104 and a first side 110a of a protection diaphragm 110. The overpressure protection system 102 can also include limiting diaphragm assemblies 106c, 106d that are in communication via capillaries 112b with both the differential pressure sensing element 104 and a second side 110b of the protection diaphragm 110.

Each of the limiting diaphragms 106a, 106b, 106c, 106d can include a cavity 114 containing a transmission fluid T sealed by a flexible diaphragm seal 116a, 116b, 116c, 116d, respectively. When the pressure P1 exceeds the pressure P2, transmission fluid T can be displaced from the limiting diaphragm 106b into the protection diaphragm 110 (e.g., the first side 110a). This displacement can allow the diaphragm seal 116b of the limiting diaphragm 106b to seat against the wall of its cavity 114 and stop further increase of differential pressure over the differential pressure sensing element 104.

However, this design can be problematic. In one aspect, the differential pressure sensor 100 can be relatively large to accommodate the volume of the transmission fluid T and the protection diaphragm 110. In another aspect, the length of the capillaries 112a, 112b can slow the response time of the differential pressure sensor 100. In an additional aspect, because the protection diaphragm 110 and the differential pressure sensing element 104 are connected to the limiting diaphragms 106b, 106d and flow of transmission fluid to the protection diaphragm 110 is not instantaneous, a portion (e.g., approximately half) of a pressure spike applied to the limiting diaphragms 106b, 106d can bypass the protection diaphragm 110 and be transmitted directly to the differential pressure sensing element 104.

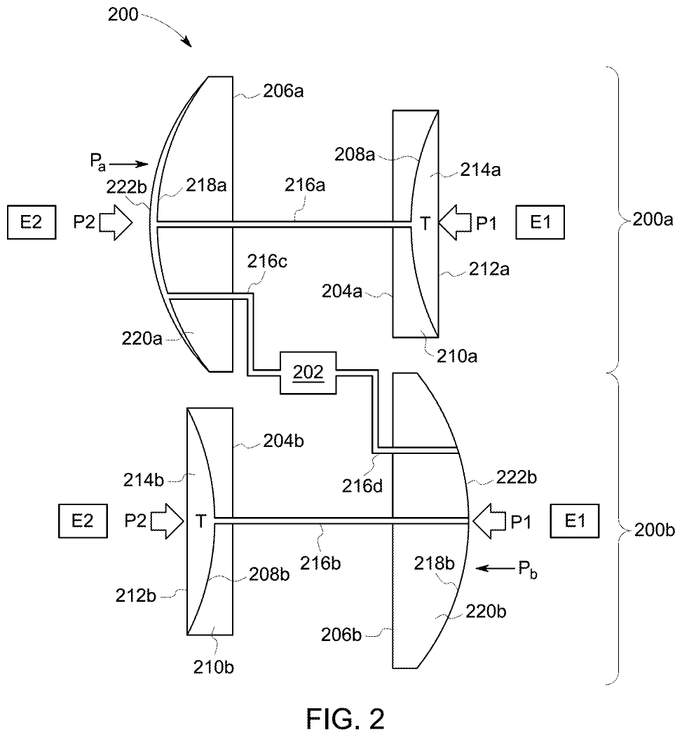

FIG. 2 illustrates one exemplary embodiment of an overpressure protection system 200 configured for protection of a differential pressure sensing element 202 that can employ a significantly lower volume of transmission fluid and can provide improved protection from rapid pressure changes. Together, the pressure sensing element 202 and the overpressure protection system 200 can form a differential pressure sensor.

The overpressure protection system 200 can include two limiting diaphragm assemblies 204 (e.g., 204a, 204b) in fluid communication with respective overpressure diaphragm assemblies 206 (e.g., 206a, 206b). The pressure sensing element 202 can include a deformable diaphragm having two sides, and a limiting diaphragm assembly 204 and an overpressure diaphragm assembly 206 can be provided on each side of the pressure sensing element 202. As discussed in detail below, each of the limiting diaphragm assemblies 204 can be configured to transmit pressure exerted by different fluid environments to their corresponding overpressure diaphragm assembly 206. The overpressure diaphragm assemblies 206 can in turn transmit pressures to the differential pressure sensing element 202, allowing measurement of a differential pressure between the different fluid environments. When pressure transmitted to either of the overpressure diaphragm assemblies 206 reaches a pre-defined limit, the limiting diaphragm assemblies 204 can be configured to inhibit transmission of further pressure increases to their corresponding overpressure diaphragm assembly 206, thus limiting pressure transmitted to the differential pressure sensing element 202.

The volume of transmission fluid T used by the overpressure protection system 200 can be relatively small. Thus, in comparison to the overpressure protection system 102, the size the overpressure protection system 200 can be reduced and its responsiveness can be increased. Furthermore, because the overpressure diaphragm assemblies 206 can be positioned in series with the differential pressure sensing element 202 and the limiting diaphragm assemblies 204 (e.g., interposed between), rather than in parallel as in the overpressure protection system 102 of FIG. 1, the differential pressure sensing element 202 can be shielded substantially entirely from overpressure transmitted during rapid pressure changes.

As shown in FIG. 2, the overpressure protection system 200 can include a first limiting diaphragm assembly 204a and a second limiting diaphragm assembly 204b. The first limiting diaphragm assembly 204a can include a first limiting diaphragm base 210a having a generally concave surface 208a and a generally planar first limiting diaphragm seal 212a defining a first cavity 214a. The first limiting diaphragm seal 212a can form a substantially fluid-tight seal with the first limiting diaphragm base 210a to enclose a transmission fluid T within the first cavity 214a. Accordingly, the transmission fluid T contained within the first cavity 214a can be kept separate from the first fluid environment E1. The pressure P1 applied by the first fluid environment E1 against the first limiting diaphragm seal 212a can be transmitted to a first overpressure diaphragm assembly 206a by the transmission fluid T via a first capillary 216a.

Similarly, the second limiting diaphragm assembly 204b can be configured for fluid communication with a second fluid environment E2 having a pressure P2. The second limiting diaphragm assembly 204b can include a second limiting diaphragm base 210b having a generally concave surface 208b and a generally planar second limiting diaphragm seal 212b defining a second cavity 214b. The second limiting diaphragm seal 212b can form a substantially fluid-tight seal with the second limiting diaphragm base 210b. Accordingly, transmission fluid T contained within the second cavity 214b can be kept separate from the second fluid environment E2. The pressure P2 applied by the second fluid environment E2 against the second limiting diaphragm assembly 204b can be transmitted to a second overpressure diaphragm assembly 206b by the transmission fluid T via a second capillary 216b.

The overpressure protection system 200 can also include the first overpressure diaphragm assembly 206a and the second overpressure diaphragm assembly 206b. As shown in FIG. 2, the first overpressure diaphragm assembly 206a can include a first overpressure diaphragm base 220a having a generally convex surface 218a and a first overpressure diaphragm seal 222a constrained thereon. The first overpressure diaphragm seal 222a can form a substantially fluid-tight seal with the first overpressure diaphragm base 220a in order to contain the transmission fluid T. The first overpressure diaphragm 206a can also be in fluid communication with the differential pressure sensing element 202 by the transmission fluid T via a third capillary 216c.

Likewise, the second overpressure diaphragm assembly 206b can include a second overpressure diaphragm base 220b having a generally convex surface 218b and a second overpressure diaphragm seal 222b constrained thereon. The second overpressure diaphragm seal 222b can form a substantially fluid-tight seal with the second overpressure diaphragm base 220b in order to contain the transmission fluid T. The second overpressure diaphragm 206b can also be in fluid communication with the differential pressure sensing element 202 by the transmission fluid T via a fourth capillary 216d.

In certain embodiments, the transmission fluid T can substantially fill the first cavity 214a, the second cavity 214b, and the capillaries 216a, 216b, 216c, 216d. That is, the portions of the overpressure protection system 200 filled with the transmission fluid T can be substantially free of any voids. The transmission fluid T can be any substantially incompressible fluid. Examples of incompressible fluids can include, but are not limited to, gels, oils (e.g., silicone oil, mineral oil, etc.), monoethylene glycol, and the like.

The first and second overpressure diaphragm seals 222a, 222b can be elastically pre-tensioned over the overpressure diaphragm bases 220a, 220b, respectively. As discussed below, this pre-tension σ can allow the overpressure diaphragm seals 222a, 222b to function as pressure actuated volume displacement switches. As shown in FIG. 2, the first overpressure diaphragm assembly 206a is positioned in fluid communication with the second fluid environment E2. As an example, the first overpressure diaphragm assembly 206a can be immersed in the second fluid environment E2. In this configuration, the pressure P2 and a residual diaphragm pressure Pₐ resulting from a pre-tension σₐ of the first overpressure diaphragm seal 222a can be applied in a direction towards the overpressure diaphragm base 220a (e.g., from left to right in FIG. 2). Concurrently, the pressure P1 can be applied in the opposite direction (e.g., from right to left in FIG. 2).

As further shown in FIG. 2, the second overpressure diaphragm assembly 206b is positioned in fluid communication with the first fluid environment E1. As an example, the second overpressure diaphragm assembly 206b can be immersed in the first fluid environment E1. In this configuration, the pressure P1 and a residual diaphragm pressure P_{b} resulting from a pre-tension σ_{b} of the second overpressure diaphragm seal 222b can be applied in a direction towards the second overpressure diaphragm base 220b (e.g., from right to left in FIG. 2). Concurrently, the pressure P2 can be applied to the second overpressure diaphragm seal 222b in the opposite direction (e.g., from left to right).

As one of the applied pressures P1, P2 increases over the other, this pressure can eventually rise to a level that exceeds the combination of the other of the applied pressures P2, P1 and the pre-tension σ of the overpressure diaphragm seal opposing it, referred to herein as a lift-off pressure P_{L}. As an example, in the circumstance that P1 increases over P2, when P1 is less than the lift-off pressure P_{L}, the residual diaphragm pressure Pₐ opposes P1 and can inhibit displacement of the first overpressure diaphragm seal 222a. When P1 rises above the lift-off pressure P_{L}, the residual diaphragm pressure Pₐ can be overcome, resulting in deflection of the first overpressure diaphragm seal 222a and creation of a space between the first overpressure diaphragm seal 222a and the first overpressure diaphragm base 220a. This space can accommodate transmission fluid T displaced from the first limiting diaphragm assembly 204a.

Similarly, in the circumstance that P2 increases over P1, when P2 is less than the lift-off pressure P_{L}, the residual diaphragm pressure P_{b} opposes P2 and can inhibit displacement of the second overpressure diaphragm seal 222b. When P2 rises above the lift-off pressure P_{L}, the residual diaphragm pressure P_{b} can be overcome, resulting in deflection of the second overpressure diaphragm seal 222b and creation of a space between the second overpressure diaphragm seal 222b and the second overpressure diaphragm base 220b. This space can accommodate transmission fluid T displaced from the second limiting diaphragm assembly 204b.

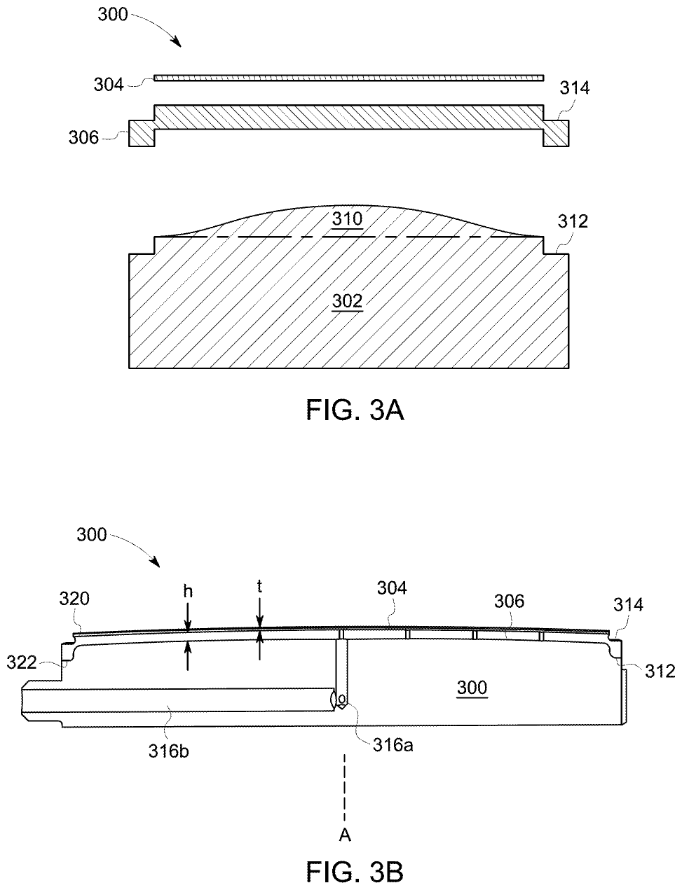

FIG. 3A illustrates an exploded view of one exemplary embodiment of a pre-tensioned overpressure diaphragm 300 suitable for use with the overpressure protection system 200 of FIG. 2. The pre-tensioned overpressure diaphragm 300 can include a base 302, a diaphragm seal 304, and a plate 306. The base 302 can include a curved surface 310 (e.g., spherical, parabolic, etc.) and a circumferential ledge 312. The plate 306 can also include a circumferential rim 314 dimensioned to mate with the circumferential ledge 312. In certain embodiments, the diaphragm seal 304 and the plate 306 can each be dimensioned to substantially cover an area of the curved surface 310. One or more of the base 302, the diaphragm seal 304, and the plate 306 can be formed from metals or metal alloys.

FIG. 3B illustrates a side cross-sectional view of the pre-tensioned overpressure diaphragm 300. As shown, the pre-tensioned overpressure diaphragm 300 can include channels 316a, 316b formed within the base 302 and in fluid communication with one another. Channel 316a can extend away from an upper surface of the base 302, and channel 316b can extend from a lateral surface of the base 302 and intersect channel 316a. So configured, channel 316b can be placed in fluid communication with a capillary (e.g., 216a, 216b) for conveying the transmission fluid T through the base 302 to the diaphragm seal 304.

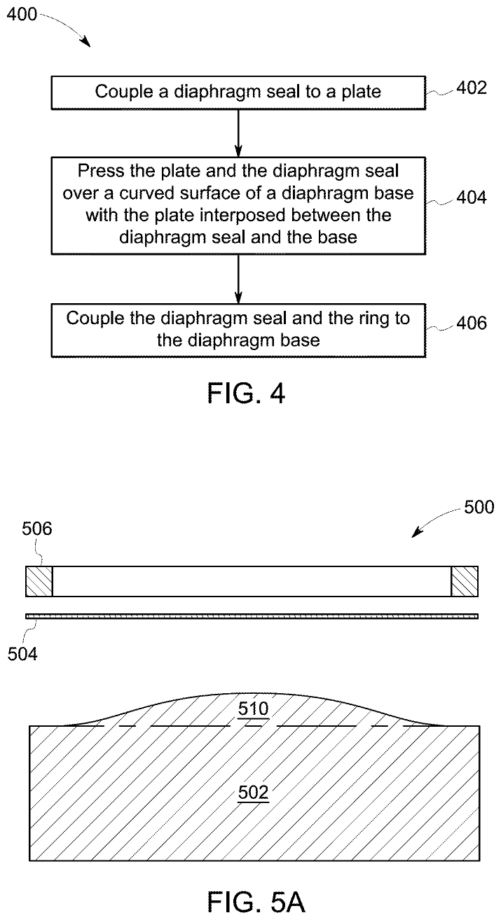

A method 400 for assembling the pre-tensioned overpressure diaphragm 300 is illustrated in FIG. 4 with further reference to FIGS. 3A-3B. In operation 402, the diaphragm seal 304 can be coupled to the plate 306 on a surface opposite the circumferential rim 314. As an example, the diaphragm seal 304 can be coupled to the plate 306 by a first couple 320. In operation 404, following operation 402, the diaphragm seal 304 and the plate 306 can be bent over the curved surface 310 of the base 302. The plate 306 can be interposed between the diaphragm seal 304 and the base 302 during operation 404. As an example, the diaphragm seal 304 and the plate 306 can be bent over the curved surface 310 of the base 302 by a pressing jig using screws. Force can be applied until gaps between the base 302, the diaphragm seal 304, and the plate 306 are substantially closed.

Bending of the plate 306 can develop tensile stresses in the diaphragm seal 304. The magnitude of these tensile stresses can be given by the geometry of the base 302, the diaphragm seal 304, and the plate 306 (e.g., the diameter and thickness of the diaphragm seal 304 and the plate 306, the radius and/or shape of the curved surface 310, etc.). An estimate of the pre-tension σ of the diaphragm seal 304 can be determined according to Equation 1:

$$σ = E \frac{h}{2 r} \qquad ( 1 )$$

where his a thickness of the plate 306, r is a radius of curvature of the base 302, and E is the modulus of elasticity of the diaphragm seal 304.

An equivalent pre-tension can be acquired between the diaphragm seal 304 and the plate 306. The resulting contact pressure can be directed approximately normal to the tangent of curvature. Thus, the diaphragm seal 304 and the plate 306 can be bent and locked in position with elastic strains serving as the pre-tension σ.

In operation 406, the diaphragm seal 304 and the plate 306 can be coupled to the base 302. As an example, the diaphragm seal 304 can be coupled to the plate 306 by a second couple 322 positioned between the circumferential ledge 312 and the circumferential rim 314. As shown in FIG. 3B, the circumferential rim 314 can be offset longitudinally and laterally from the diaphragm seal 304 with respect to an axis A. As a result, the weld 322 coupling the plate 306 to the base 302 can be positioned between the circumferential ledge 312 and the circumferential rim 314. This configuration can distance the diaphragm seal 304 from heat affected zones of the second couple 322 and it can avoid relaxation of the pre-tension σ due to the heat affected zones of the second 322.

The first and second 320, 322 can be gas tight and can hold the pre-tension σ and the pressure load. Examples can include welds, adhesives, friction fits, and the like. Without being bound by theory, when the first and second couples are in the form of welds, thermal shrinkage can occur upon cooling of the second couple 322 and can create a torque that works in the curvature direction. Thus, the welding process can help stretch the diaphragm seal 304 and facilitate imposing the pre-tension σ in the diaphragm seal 304.

The pre-tension σ of the diaphragm seal 304 can allow it to resist deflection in response to pressure transmitted to the pre-tensioned overpressure diaphragm 300 up to the lift-off pressure P_{L}. The lift-off pressure P_{L} can be a function the pre-tension σ and it can be estimated according to Equation 2:

$${P}_{L} = \frac{2 σ t}{r} = E \frac{ht}{{r}^{2}} \qquad ( 2 )$$

where t is the thickness of the diaphragm seal 304. Accordingly, the lift-off pressure P_{L} can be selected by shaping the base 302 to the deflection profile of the diaphragm seal 304 at the selected lift-off pressure P_{L}.

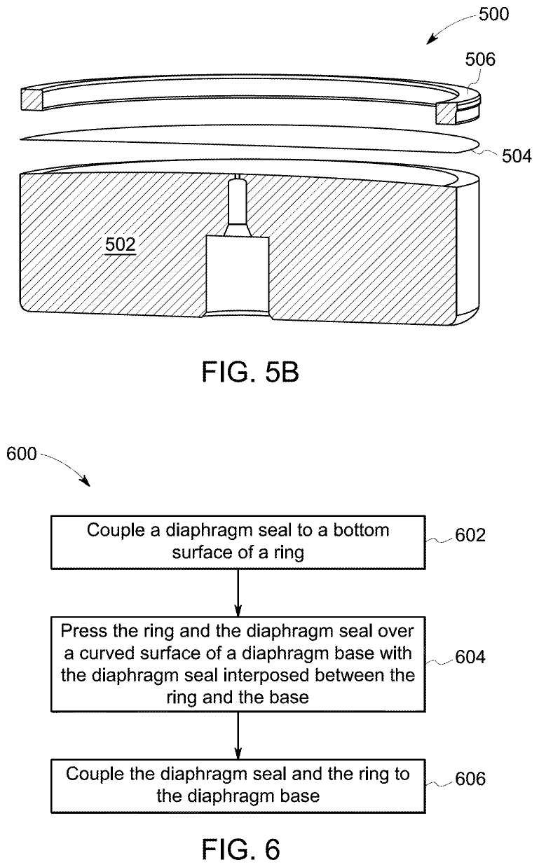

FIGS. 5A-5B illustrate another exemplary embodiment of a pre-tensioned overpressure diaphragm 500 suitable for use with the overpressure protection system 200 of FIG. 2. The pre-tensioned overpressure diaphragm 500 can include a base 502, a diaphragm seal 504, and a ring 506 configured to pre-tension the diaphragm seal 504. In certain embodiments, the base 502 can also include a curved surface 510 (e.g., spherical, parabolic, etc.).

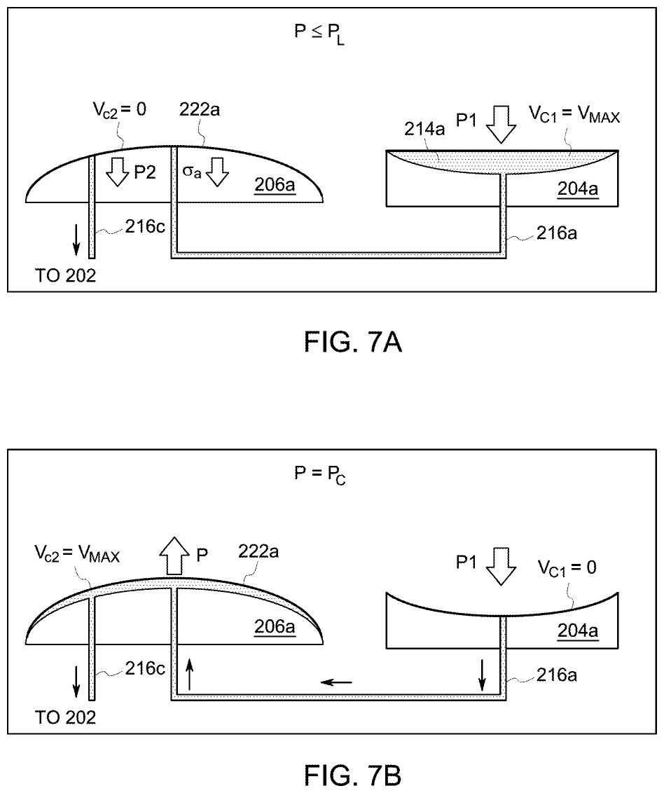

A method 600 for assembly of the pre-tensioned pressure overpressure diaphragm 500 is illustrated in FIG. 6 with further reference to FIGS. 5A-5B. In operation 602, the diaphragm seal 504 can be coupled to a bottom surface of the ring 506 (e.g., by welding). In operation 604, following operation 602, the diaphragm seal 504 and the ring 506 can be pressed over a curved surface 510 of the base 502. The diaphragm seal 504 can be interposed between the ring 506 and the base 502 during operation 604. As an example, the ring 506 can be pressed over the base 502 by a pressing jig using screws. Force can be applied until gaps between the base 502, the diaphragm seal 504, and the ring 506 are substantially closed. In operation 606, the diaphragm seal 504 and the ring 506 can be coupled to the base 502 (e.g., by welding).

It can be understood that, while embodiments of structures and methods for pre-tensioning the overpressure protection diaphragms, other approaches that elastically deform the diaphragm seal over a curvature and secure the diaphragm seal in place can be employed to impose the pre-tension. Further details illustrated and/or described, such as cavities and weld reliefs can be implemented in such designs as well.

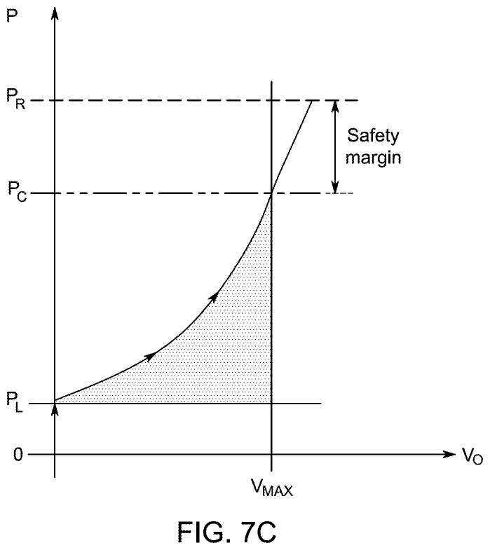

Use of the overpressure protection system 200 for limiting transmission of pressure to the differential pressure sensing element 202 is illustrated in FIGS. 7A-7B with reference to the first limiting diaphragm 204a, the first overpressure diaphragm 206a, and the capillaries 216a, 216c. The remainder of the overpressure protection system 200 is omitted for clarity. However, the discussion below is also applicable to the second limiting diaphragm 204b, the second overpressure diaphragm 206b, and the capillaries 216b, 216d.

As shown in FIGS. 7A-7B, the first cavity 214a of the first limiting diaphragm 204a can store a volume V_{c1} of the transmission fluid T and the first overpressure diaphragm 206a can store a volume V_{c2} of the transmission fluid T (e.g., between the first overpressure diaphragm base 220a and the first overpressure diaphragm seal 222a). In an initial state, prior to application of the pressure P1 to the first limiting diaphragm 204a, volume V_{c2} can be approximately zero and volume V_{c1} can be at a maximum value V_{MAX}. The first overpressure diaphragm seal 222a can also apply a pressure equal to the lift-off pressure P_{L} to the first overpressure diaphragm base 220a due to the pre-tension σ. As a result, the overpressure diaphragm seal 222a can substantially abut the overpressure diaphragm base 220a.

When pressure P1 is less than or equal to the lift-off pressure P_{L}, pressure P1 can be transmitted to the first overpressure diaphragm 206a. However, pressure P1 can be insufficient to overcome the pre-tension σₐ of the first overpressure diaphragm seal 222a necessary to cause it to displace. Thus, flow of the transmission fluid T can be substantially inhibited between the first limiting diaphragm 204a and the first overpressure diaphragm 206a and volume V_{O} and volume V_{C} can remain approximately unchanged (FIG. 7A).

In certain embodiments, the first overpressure diaphragm 206a can be configured to allow a small volume of transmission fluid T (not shown) to flow through the capillary 216c between the first overpressure diaphragm 206a and the differential pressure sensing element 202. While negligible compared to volume V_{MAX}, the volume of flow can be sufficient to allow measurement of the pressure P1 by the differential pressure sensing element 202 and/or accommodate volumetric changes of the transmission fluid T due to compressibility and thermal expansion.

This condition can be reflected in FIG. 7C, which plots a pressure P transmitted to the first overpressure diaphragm 206a and the volume V_{O} between the first overpressure diaphragm base 220a and the first overpressure diaphragm seal 222a. As shown in FIG. 7C, the pressure P can rise from zero to the lift-off pressure P_{L} while volume V_{O} remains approximately zero.

As pressure P1 increases from the lift-off pressure P_{L} to a pressure less than the cut-off pressure P_{C}, the pre-tension σ of the first overpressure diaphragm seal 222a can be overcome, resulting in deflection of the first overpressure diaphragm seal 222a. This deflection can provide space between the first overpressure diaphragm base 220a and the first overpressure diaphragm seal 222a to accommodate flow of the transmission fluid T from the first limiting diaphragm 204a to the first overpressure diaphragm 206a. As a result, volume V_{O} can increase and volume V_{C} can decrease. In turn, the first limiting diaphragm seal 212a can deflect towards, but remain distanced from, the first cavity 214a. This condition can be reflected in the P-V diagram of FIG. 7C by a rise in pressure P from the lift-off pressure P_{L} with a corresponding increase in volume V_{O}. Pressure P1 can continue to be transmitted within the capillary 216c from the first overpressure diaphragm 206a to the differential pressure sensing element 202 by the transmission fluid.

When pressure P1 approximately equals the cut-off pressure P_{C}, the first overpressure diaphragm seal 222a can deflect by an amount sufficient to accommodate a volume of transmission fluid T equal to volume V_{MAX}. Accordingly, volume V_{C} can be approximately zero and the first limiting diaphragm seal 212a can seat against the first cavity 214a. As a result, transmission of further pressure increases from the first limiting diaphragm 204a to the first overpressure diaphragm 206a, and from the first overpressure diaphragm 206a to the differential pressure sensing element 202, can be cut-off (FIG. 7B). This condition can be reflected in the P-V diagram of FIG. 7C by a rise in pressure P to the cut-off pressure P_{C} with a corresponding increase in volume V_{O} to volume V_{MAX}.

Under certain circumstances, the first pressure can exceed the cutoff pressure P_{C}. In one aspect, the first pressure can exceed the cutoff pressure P_{C}, due to a volume increase of the transmission arising from an increase in the temperature of the transmission fluid T. In another aspect, the first pressure can also exceed the cutoff pressure P_{C} when the first pressure exhibits a spike, increasing at a rate faster than the overpressure diaphragm seal 222b can deflect. As further illustrated in FIG. 7C, the first overpressure diaphragm seal 222a can be configured to maintain a substantially fluid-tight seal with the first overpressure diaphragm base 220a at pressures that exceed the cut-off pressure P_{C}, up to a rupture pressure P_{R}. The rupture pressure P_{R} can be greater than or equal to a maximum operating pressure of the differential pressure sensing element 202. When pressure exerted against to the first overpressure diaphragm seal 222b exceeds the rupture pressure P_{R}, the fluid-tight seal between the first overpressure diaphragm seal 222b and the first overpressure diaphragm base 220a can be broken.

The ability of the first overpressure diaphragm seal 222b to maintain a substantially fluid-tight seal up to the rupture pressure P_{R} provides a number of advantages. In one aspect, the first overpressure diaphragm seal 222b can provide a safety margin that allows for operation between cutoff pressure P_{C} and the rupture pressure P_{R}. Furthermore, the ability of the first overpressure diaphragm seal 222b to break at the rupture pressure P_{R} protects the expensive differential pressure sensing element 202 from damage due to pressure beyond its designed operating limit.

The overpressure protection system 200 can also provide protection from rapid pressure changes (e.g., dynamic overpressure) using the same mechanisms. Rapid pressure changes can occur in either of environment E1 or environment E2. As an example, a clogged tapping within either environment E1 or environment E2 upstream from the overpressure protection system 200 can cause a pressure buildup behind the clog. When the pressure level behind the clog rises to a level sufficient to clear the clog, a pressure spike can be transmitted to the corresponding limiting diaphragm 204a, 204b. However, because the overpressure diaphragms 206a, 206b are interposed between the limiting diaphragms 204a, 204b and the differential pressure sensing element 202, by the same mechanisms discussed above, the differential pressure sensing element 204 can be shielded from the pressure spikes in excess of the cutoff pressure P_{C}.

In further embodiments, two or more pressure sensing elements employing overpressure protection systems similar to the overpressure protection system 200 of FIG. 2 can be combined to provide a compound pressure sensor configured to measure a pressure difference between a pressure P₁ and a pressure P₂.

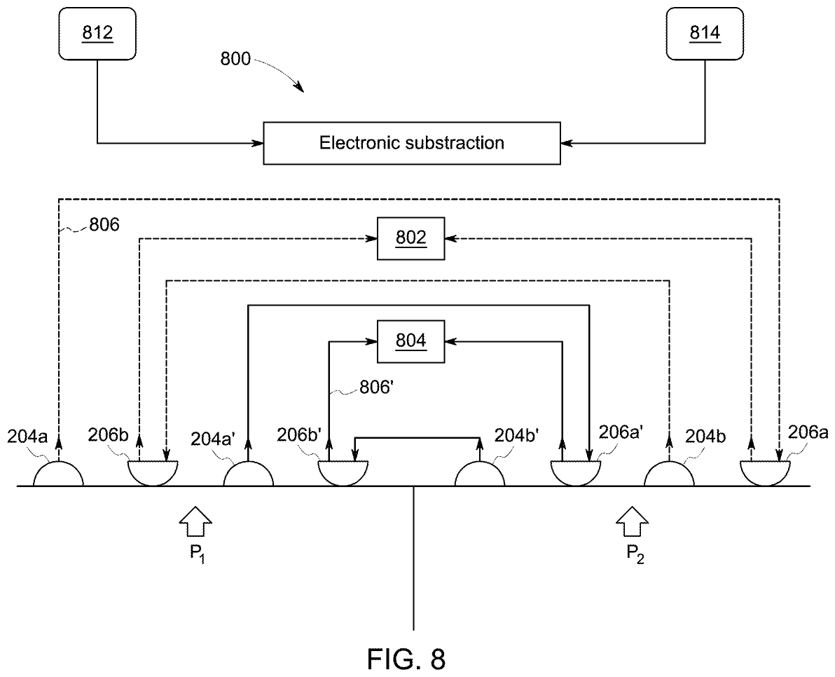

As shown in FIG. 8, a compound pressure sensor 800 can include a first differential pressure sensing element 802 and a second differential pressure sensing element 804. The differential pressure sensing elements 802, 804 can be rated for measuring differential pressure over different pressure ranges with high accuracy. In one embodiment, the first differential pressure sensing element 802 can be configured to provide differential pressure measurements between about −2 bar and about 2 bar and the second differential pressure sensing element 804 can be configured to provide differential pressure measurements between about −350 mbar and about 350 mbar.

The first differential pressure sensing element 802 can be in communication with a first overpressure protection system 806 and the second differential pressure sensing element 804 can be in communication with a second overpressure protection system 806′. For clarity, the first and second overpressure protection systems 806, 806′ are illustrated in FIG. 8 with concave semicircles to represent limiting diaphragm assemblies (e.g., 204a, 204b, 204a′, 204b′) and convex semicircles representing overpressure diaphragm assemblies (e.g., 206a, 206b, 206a′, 206b′).

The compound pressure sensor 800 can also include two absolute pressure elements for acquiring absolute pressure measurements. A first absolute pressure element 812 can be configured to measure pressure P₁ with zero reference to a perfect vacuum (absolute pressure of P₁) and a second absolute pressure element 814 can be configured to measure pressure P2 with zero reference to a perfect vacuum (absolute pressure of P₁). The differential pressure can be can be determined by electronic subtraction. A differential pressure measurement acquired in this manner can cover a range all the way up to a line pressure. The measured differential pressure can also be used for line pressure compensation and for input to other systems (e.g., for density calculations).

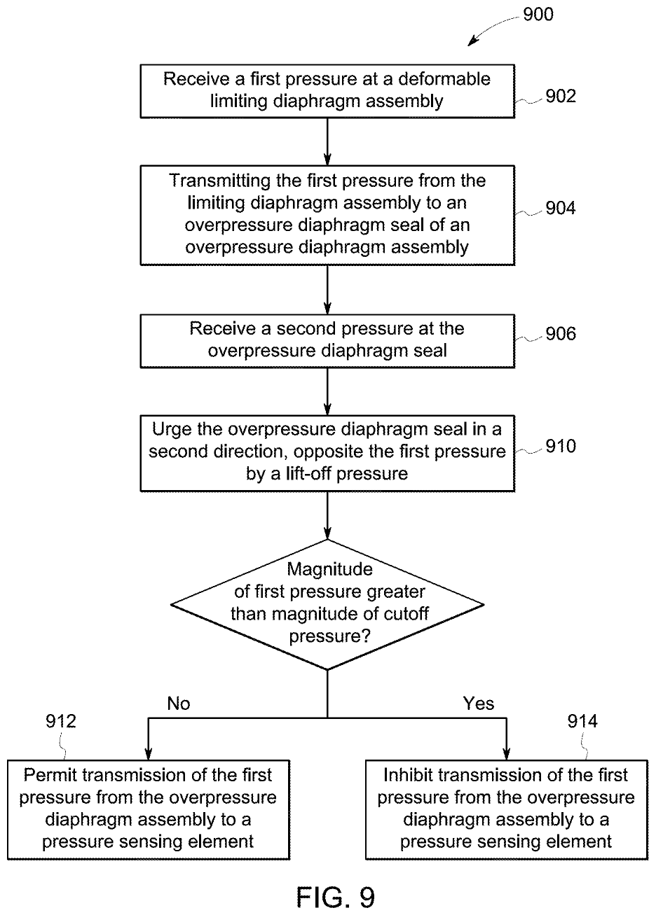

FIG. 9 is a flow diagram illustrating one exemplary embodiment of a method 900 for overpressure protection. For clarity, the method 900 is discussed below in the context of the overpressure protection system 200 for protection of pressure sensing element 202 from a first pressure. However, embodiments of the method can also be employed to protect the pressure sensing element 202 from a second pressure.

As shown, the method 900 includes operations 902, 904, 906, 910, 912, and 914.

However, embodiments of the method can omit or add one or more operations and the operations can be performed in an order different than illustrated in FIG. 9.

In operation 902, a first pressure (e.g., P1) can be received at a deformable limiting diaphragm assembly (e.g., first limiting diaphragm assembly 204a). The first limiting diaphragm assembly 204a can be in fluid communication with the first fluid environment E1 and receive the first pressure P1 at the first limiting diaphragm seal 212a.

In operation 904, the first pressure can be hydraulically transmitted from the first limiting diaphragm assembly 204a to an overpressure diaphragm assembly (e.g., first overpressure diaphragm assembly 206a). As discussed above, the first overpressure diaphragm assembly 206a can include the overpressure diaphragm base 220a and the overpressure diaphragm seal 222a can be coupled to the generally convex surface 218a. The first pressure P1 can be applied to an underside of the overpressure diaphragm seal 222a. That is, in a direction that is towards the overpressure diaphragm seal 222a and away from the convex surface 218a.

In operation 906, the first overpressure diaphragm seal 222a can receive a second pressure (e.g., P2). As an example, the first overpressure diaphragm assembly 206a can be in fluid communication with the second fluid environment E2 and receive the second pressure P2 at the first limiting diaphragm seal 212a.

In operation 910, the overpressure diaphragm seal 222a can be urged towards the overpressure diaphragm base 220 (e.g., in a direction opposing the first pressure), by a lift-off pressure (e.g., P_{L}). The lift-off pressure P_{L} can be approximately equal to the sum of the second pressure and the residual diaphragm pressure of the overpressure diaphragm seal 222a.

In operation 912, transmission of the first pressure P1 from the overpressure diaphragm assembly 206a to a pressure sensing element (e.g., differential pressure sensing element 202) can be permitted when the first pressure P1 is less than or equal to the cutoff pressure. As discussed above, the lift-off pressure P_{L} opposes the first pressure P1. When the first pressure P1 is less than or equal to the lift-off pressure P_{L}, the overpressure diaphragm seal 222a does not deflect. Under these conditions, a volume of a transmission fluid T can flow between the first overpressure diaphragm 206a and the differential pressure sensing element 202 that is sufficient to allow measurement of the pressure P1 by the differential pressure sensing element 202.

In operation 914, transmission of the first pressure from the overpressure diaphragm assembly 206a to a pressure sensing element (e.g., pressure sensing element 202) can be inhibited when the first pressure is greater than the cutoff pressure P_{C}. As also discussed above, when the first pressure P1 is greater than the cutoff pressure P_{C}, the overpressure diaphragm seal 222a can deflect by an amount sufficient to cause the first limiting diaphragm seal 212a to seat against the first cavity 214a. As a result, transmission of further pressure increases from the first limiting diaphragm 204a to the first overpressure diaphragm 206a, and from the first overpressure diaphragm 206a to the differential pressure sensing element 202, can be cut-off.

Exemplary technical effects of the methods, systems, and devices described herein include, by way of non-limiting example, protection of differential pressure sensors from rapid spikes in differential pressure that can employ a low volume and compact design.

Certain exemplary embodiments have been described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. An overpressure protection system, comprising:
a limiting diaphragm assembly configured to receive a first pressure from a first fluid environment; and
an overpressure diaphragm assembly including an overpressure diaphragm assembly base having a generally convex surface and an overpressure diaphragm seal coupled to the convex surface, the overpressure diaphragm assembly being configured to receive the first pressure from the limiting diaphragm assembly via hydraulic communication with a transmission fluid at a first side of the overpressure diaphragm seal, and to receive a second pressure from a second fluid environment at a second side of the overpressure diaphragm seal, opposite the first side;
wherein the overpressure diaphragm seal is biased towards the convex surface by a lift-off pressure, the magnitude of the lift-off pressure being approximately equal to the sum of the magnitudes of the second pressure and a pre-defined residual diaphragm pressure of the overpressure diaphragm seal;
wherein the transmission fluid exerts the first pressure on the overpressure diaphragm seal in a direction opposite the lift-off pressure; and
wherein the limiting diaphragm assembly and the overpressure diaphragm assembly are configured to allow transmission of the first pressure having a magnitude less than or equal to a pre-defined cutoff pressure to a pressure sensing element and to inhibit transmission of the first pressure having a magnitude greater than the cutoff pressure to the pressure sensing element, the magnitude of the cutoff pressure being greater than the magnitude of the lift-off pressure.

2. The overpressure protection system of claim 1, wherein the limiting diaphragm assembly comprises:
a limiting diaphragm base having a generally concave surface, and
a generally planar limiting diaphragm seal overlying the concave surface and coupled to the limiting diaphragm base;
wherein the limiting diaphragm base and the limiting diaphragm seal define a first cavity in the limiting diaphragm base having a first cavity volume V_{c1} substantially filled with the transmission fluid, and
wherein the overpressure diaphragm seal separates the transmission fluid from the first fluid environment and receives the first pressure.

3. The overpressure protection system of claim 2, wherein a second cavity having a second cavity volume V_{c2} is defined between the overpressure diaphragm seal and the concave surface of the overpressure diaphragm base.

4. The overpressure protection system of claim 3, wherein, when the first pressure is less than or equal to the lift-off pressure, the overpressure diaphragm seal is configured to substantially abut the overpressure diaphragm base and the second cavity volume V_{c2} is approximately zero.

5. The overpressure protection system of claim 3, wherein, when the first pressure is greater than the lift-off pressure and less than the cutoff pressure, the overpressure diaphragm seal is configured to deflect away from the overpressure diaphragm base such that the second cavity volume V_{c2} is less than the first cavity volume V_{c1}.

6. The overpressure protection system of claim 5, wherein the limiting diaphragm seal is configured to deflect towards the limiting diaphragm base in response to deflection of the overpressure diaphragm seal and to urge a volume of transmission fluid substantially equal to the second cavity volume V_{c2} from the first cavity to the second cavity.

7. The overpressure protection system of claim 3, wherein, when the first pressure is substantially equal to the cutoff pressure, the overpressure diaphragm seal is configured to deflect away from the overpressure diaphragm base such that the second cavity volume V_{c2} is substantially equal to the first cavity volume V_{c1}.

8. The overpressure protection system of claim 7, wherein the limiting diaphragm seal is configured to deflect towards the limiting diaphragm base in response to deflection of the overpressure diaphragm seal and to urge a volume of transmission fluid substantially equal to the first cavity volume V_{c1} from the first cavity to the second cavity.

9. The overpressure protection system of claim 3, wherein, when the first pressure is greater than the cutoff pressure, the limiting diaphragm seal is configured to seat against the limiting diaphragm base and to inhibit transmission of the first pressure greater than the cutoff pressure to the overpressure diaphragm assembly.

10. The overpressure protection system of claim 1, wherein the coupling between the overpressure diaphragm seal and the overpressure diaphragm base is configured to be broken when the first pressure exceeds a predefined rupture pressure greater than the cutoff pressure.

11. The overpressure protection system of claim 10, wherein the rupture pressure is less than or equal to a maximum pressure of the pressure sensing element.

12. A pressure sensor, comprising:
the pressure sensing element; and
the overpressure protection system of claim 1 in hydraulic communication with the pressure sensing element by the transmission fluid.

13. A method for overpressure protection, comprising:
receiving a first pressure from a first fluid environment at a deformable limiting diaphragm assembly;
hydraulically transmitting the received first pressure from the limiting diaphragm assembly to an overpressure diaphragm assembly by a transmission fluid, wherein the first pressure is applied to an overpressure diaphragm seal coupled to a generally convex surface of an overpressure diaphragm base in a first direction away from the overpressure diaphragm base;
receiving a second pressure from a second fluid environment at the overpressure diaphragm seal;
urging the overpressure diaphragm seal in a second direction, opposite the first direction and towards the overpressure diaphragm base, by a lift-off pressure, wherein the lift-off pressure is approximately equal to the sum of a pre-defined residual diaphragm pressure of the overpressure diaphragm seal and the second pressure; and
inhibiting transmission of the first pressure from the overpressure diaphragm assembly to a pressure sensing element by the transmission fluid when the magnitude of the first pressure is greater than a magnitude of a pre-defined cutoff pressure;
wherein the magnitude of the cutoff pressure is greater than the magnitude of the lift-off pressure.

14. The method of claim 13, further comprising permitting transmission of the first pressure from the overpressure diaphragm assembly to the pressure sensing element by the transmission fluid when the magnitude of the first pressure is less than or equal to the magnitude of the cutoff pressure.

15. The method of claim 13, further comprising:
containing a volume V_{c1} of transmission fluid within a first cavity of the limiting diaphragm assembly, the transmission fluid substantially filling the first cavity;
deflecting the overpressure diaphragm seal in the first direction when the first pressure is greater than the lift-off pressure, thereby defining a second cavity having a volume V_{c2} between the overpressure diaphragm seal and the overpressure diaphragm base; and
transferring a portion of the transmission fluid substantially equal to volume V_{c2} from the first cavity to the second cavity.

16. The method of claim 15, wherein the volume V_{c2} is approximately zero when the first pressure is less than or equal to the lift-off pressure.

17. The method of claim 15, wherein the volume V_{c2} is less than the volume V_{c1} when the first pressure is less than the cutoff pressure.

18. The method of claim 15, wherein the volume V_{c2} is substantially equal to the volume V_{c1} when the first pressure is substantially equal to the cutoff pressure.

19. The method of claim 13, comprising breaking the coupling between the overpressure diaphragm seal and the overpressure diaphragm base when the first pressure is greater than a rupture pressure, the rupture pressure being greater than the cutoff pressure.
